(19) United States
(12) Patent Application Publication
(10) Pub. No.: US 2007/0230519 A1
(43) Pub. Date: Oct. 4, 2007

(54) GREEN OPTICAL MODULE

(76) Inventors: Du-Chang HEO, Suwon-si (KR); Sung-Soo Park, Suwon-si (KR)

Correspondence Address: CHA & REITER, LLC, 210 ROUTE 4 EAST STE 103, PARAMUS, NJ, 07652, US

(21) Appl. No.: 11/672,624

(22) Filed: Feb. 8, 2007

(30) Foreign Application Priority Data
Mar. 29, 2006 (KR) 2006-28349

(51) Int. Cl. H01S 3/10; H01S 3/04

(52) U.S. Cl. 372/22; 372/36

(57) ABSTRACT

A green optical module is disclosed. The module includes a harmonic generator for generating a second harmonic, a laser light source for generating light for pumping the harmonic generator and at least two heat sinks spaced from each other. The harmonic generator and the laser light source are disposed on upper surfaces of the heat sinks, respectively.

### CLAIM OF PRIORITY

This application claims the benefit under 35 U.S.C. 119(a) of an application entitled “Green Optical Module,” filed in the Korean Intellectual Property Office on Mar. 29, 2006 and assigned Serial No. 2006-28349, the entire contents of which are incorporated herein by reference.

### BACKGROUND OF THE INVENTION

1. Field of the Invention

The present invention relates to a light source capable of generating laser light of a green wavelength, and more particularly to a light source which includes a second harmonic generator and that can create green light.

2. Description of the Related Art

Green light is one of three primary colors required for implementing a laser image projector. The laser image projector may be implemented with laser light sources for generating the three primary light colors, a space modulator for spatially modulating each light generated by the laser light sources, various types of optical systems, and a driving unit for driving and controlling the components.

Semiconductor lasers may be used as the light sources for red and blue light, but conventional semiconductor lasers are no capable of being used for a green optical source. For this reason, an optical module including a second harmonic generator has been used to implement a green laser. Laser light is converted for pumping into a second harmonic and to output the second harmonic.

For example, in a conventional green laser pointer uses a diode that produces an infrared beam. Infrared photons are used to pump a second lasing material, a crystal, which produces light of a different wavelength that is converted to green through a frequency-doubling process.

Currently, there is a growing demand for portable digital devices, such a mobile laser projection display device. In order to implement such a mobile laser projection display device, it is necessary to achieve miniaturization and lower the power consumption of the device.

However, conventional light sources for generating green-wavelength laser light have only generally been designed for use as a pointer. Such green light sources have a problem in that its operation property is easily changed depending on change in temperature. While some laser light sources capable of generating a green wavelength can be made relatively stable regardless of temperature change, they must be equipped with additional elements for the stability against temperature, which increase the volume of the laser light source.

### SUMMARY OF THE INVENTION

One aspect of the present invention is to provide a green optical module, which can ensure a stable operation characteristic against temperature change for each element while having a small volume.

One embodiment of the present invention is directed to a green optical module including a harmonic generator for generating a second harmonic, a laser light source for generating light for pumping the harmonic generator and at least two heat sinks spaced from each other. The harmonic generator and the laser light source are disposed on upper surfaces of the heat sinks, respectively.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a view illustrating a green optical module according to a first embodiment of the present invention; and

FIG. 2 is a view illustrating a green optical module according to a second embodiment of the present invention,

### DETAILED DESCRIPTION

Hereinafter, embodiments of the present invention will be described with reference to the accompanying drawings. For the purposes of clarity and simplicity, a detailed description of known functions and configurations incorporated herein will be omitted when it may obscure the subject matter of the present invention.

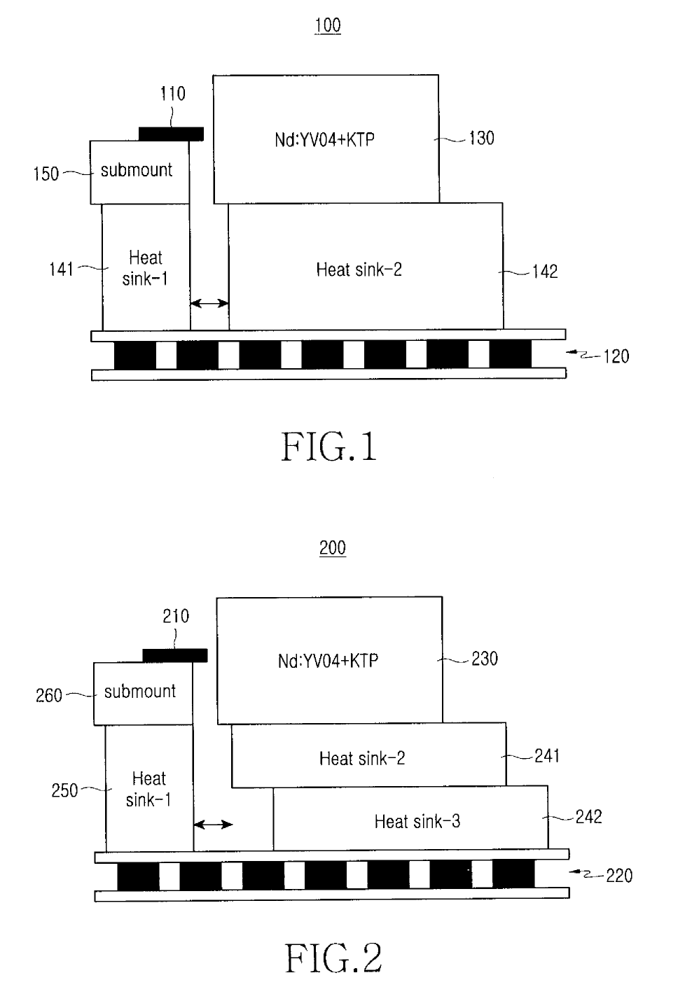

FIG. 1 is a view illustrating a green optical module 100 according to a first embodiment of the present invention. The green optical module 100 includes a harmonic generator 130 for generating a second harmonic, a laser light source 110 for generating light for pumping the harmonic generator 130, two or more heat sinks 141 and 142. The harmonic generator 130 and the laser light source 110 are disposed on the two or more heat sinks 141 and 142, respectively. The module 100 also includes a thermoelectric cooling element 120. Although the laser light source 110 discharges heat through the corresponding heat sink 141 and a submount 150, the harmonic generator 130 may include a DMP crystal and may form a resonance region due to a thermal lens effect. Such a resonance region may cause a malfunction of the laser light source 110. In order to solve such a problem, the laser light source 110 and harmonic generator 130 are positioned in contact with the heat sinks 141 and 142. For example, as shown in FIG. 1 the laser light source 110 and harmonic generator 130 are disposed on the heat sinks 141 and 142, respectively, which have thermal conductivities, so that it is possible to obtain a more stable thermal property and cooling effect.

The heat sink 141 on which the laser light source 110 is disposed and the heat sink 142 on which the harmonic generator 130 is disposed are disposed on the thermoelectric cooling element 120 while being spaced from each other. Note that the spacing of the heat sinks is determined by the spacing between a pumping LD and a harmonic generator. It is possible to obtain an effective thermal stability by adjusting the thermal conductivities and thicknesses of the heat sinks 141 and 142 as needed.

The heat sinks 141 and 142 are positioned in contact with the thermoelectric cooling element 120 while being spaced from each other. For example, as shown in FIG. 1, the heat sinks 141 and 142 are disposed on of an upper surface of the thermoelectric cooling element 120 while being spaced from each other. The heat sinks 141 and 142 function to independently cool the laser light source 110 and harmonic generator 130, respectively. Although one thermoelectric cooling element 120 is shared with each other, the laser light source 10 and harmonic generator 130 are respectively disposed on the heat sinks 141 and 142 spaced from each other, so that it is possible to improve the cooling effects of the laser light source 110 and harmonic generator 130, and to minimize the risk of a malfunction due to thermal interference there between.

The laser light source 110 may include a semiconductor laser, which can generate laser light having a wavelength of 808 nm so as to pump the harmonic generator 130. The submount 150 may be additionally inserted between the laser light source 110 and the heat sink 141.

The harmonic generator 130 may include Nd:YV04 (DMP crystal) and KTP. and the harmonic generator 130 is pumped by light generated by the laser light source 110, and then generates a second harmonic. For example, the Nd:YV04 is pumped by light generated by the laser light source 110 and generates light of 1064 nm, and the KTP may convert the light of 1064 nm generated by the Nd:YV04 into light of 532 nm and output the light of 532 nm.

FIG. 2 is a view illustrating a green optical module 200 according to a second embodiment of the present invention. The green optical module 200 includes a harmonic generator 230 for generating a second harmonic, a laser light source 210 for generating light for pumping the harmonic generator 230, at least a first heat sink 250, and at least two second heat sinks 241 and 242, a thermoelectric cooling element 220, and a submount 260. The thermoelectric cooling element 220 is provided on the upper surface thereof with the first and second heat sinks 250 and 242, which are spaced from each other.

The submount 260 may be inserted between the first heat sink 250 and the laser light source 210, and the second heat sinks are inserted between the thermoelectric cooling element 220 and the harmonic generator 230.

The first and second heat sinks 250, 241 and 242 may be made from Cu, Kovar, Al203, SiC, Si, or an alloy thereof, and may be made from SUSS, Invar, or AlN. An interval between the first heat sink 250 and the second heat sinks 241 and 242, the thermal conductivities and thicknesses thereof may be changed depending on necessities of optical modules to which the heat sinks are applied.

The first heat sink 250 is disposed on the thermoelectric cooling element 220 while being spaced a predetermined interval from the second heat sinks 241 and 242. The second heat sinks 241 and 242 are located between the harmonic generator 230 and the thermoelectric cooling element 220. Also, the thicknesses and materials of the second heat sinks 241 and 242 may be determined according to the thermal property of the harmonic generator 230, and the number of the second heat sinks may be also changed depending on usage conditions.

As described above, the temperatures of the harmonic generator and laser light source are independently and simultaneously compensated by using heat sinks spaced from each other, which can be applied to a green optical module having a small volume. In addition, since the materials and thicknesses of the heat sinks corresponding to the laser light source and harmonic generator can be determined according to necessity, it is possible to easily ensure an optimum thermal stability and to minimize the volume of the green optical module.

Also, since the harmonic generator and the laser light source use separate heat sinks, it is possible to minimize the risk of a malfunction due to thermal interference between elements.

While the present invention has been shown and described with reference to certain embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A green optical module comprising:
a harmonic generator for generating a second harmonic;
a laser light source for generating light for pumping the harmonic generator; and
at least two heat sinks spaced from each other, wherein the harmonic generator and the laser light source are disposed on upper surfaces of the heat sinks, respectively.

2. The green optical module as claimed in claim 1, further comprising a thermoelectric cooling element having an upper surface on which the heat sinks are spaced apart from each other by a predetermined interval.

3. The green optical module as claimed in claim 1, further comprising a submount which is inserted between the laser light source and a corresponding heat sink.

4. The green optical module as claimed in claim 1, wherein the heat sinks are made from Cu, Kovar, Al203, SiC, Si, or an alloy thereof.

5. The green optical module as claimed in claim 1, wherein the heat sinks are made from SUSS, Invar, or AlN.

6. A green optical module comprising:
a harmonic generator for generating a second harmonic;
a laser light source for generating light for pumping the harmonic generator;
a thermoelectric cooling element for cooling the laser light source and the harmonic generator;
at least one heat sink inserted between the thermoelectric cooling element and the laser light source; and
at least two heat sinks inserted between the thermoelectric cooling element and the harmonic generator.

7. The green optical module as claimed in claim 6, wherein each of the second heat sinks has a thickness and is made from a material, which are determined based on a thermal property of the harmonic generator.

8. An optical module comprising:
a harmonic generator capable of generating a second harmonic;
a laser light source capable of generating light for pumping the harmonic generator; and
at least two heat sinks not in direct contact with each other,
wherein the harmonic generator and the laser light source are each in contact with one of the at least two heat sinks, respectively.

9. The optical module as claimed in claim 8, wherein the optical module is a green-light optical module.

10. The optical module as claimed in claim 8, further comprising a thermoelectric cooling element that is positioned in contact with the at least two heat sinks.

11. The optical module as claimed in claim 8, further comprising a submount which is inserted between the laser light source and a corresponding one of the at least two heat sinks.

12. The optical module as claimed in claim 8, wherein the at least two heat sinks are made from Cu, Kovar, Al203, SiC, Si, or an alloy thereof.

13. The optical module as claimed in claim 8, wherein the at least two heat sinks are made from SUSS, Invar, or AlN.

14. The optical module as claimed in claim 8, wherein at least one of the at least two heat sinks is formed use two sub-heat sinks.
